(19) United States
(12) Patent Application Publication
(10) Pub. No.: US 2024/0386886 A1
(43) Pub. Date: Nov. 21, 2024

(54) GENERATING AND UPDATING A CUSTOM AUTOMATED ASSISTANT BASED ON A DOMAIN-SPECIFIC RESOURCE

(71) Applicant: GOOGLE LLC, Mountain View, CA (US)

(72) Inventors: Matthew Sharifi, Kilchberg (CH); Victor Carbune, Zurich (CH)

(21) Appl. No.: 18/197,573

(22) Filed: May 15, 2023

(51) Int. Cl. G10L 15/22

(52) U.S. Cl. CPC G10L 15/22

(57) ABSTRACT

Implementations herein related to customizing an automated assistant using domain-specific resources. One or more resources are processed to generate a natural language representation of the contents of the resources. The natural language representation is utilized to customize an automated assistant for interactions with a user. Various implementations include priming and fine-tuning large language models that are utilized to implement the automated assistant. Various implementations are directed to biasing speech recognition based on terms identified in the resources. Various implementations are directed to customizing the tone of the automated assistant based on information included in the resources.

### BACKGROUND

Humans can engage in human-to-computer dialogs with interactive software applications referred to herein as “automated assistants” (also referred to as “chat bots,” “interactive personal assistants,” “intelligent personal assistants,” “personal voice assistants,” “conversational agents,” etc.). For example, a human (which when interacting with an automated assistant may be referred to as a “user”) may provide an explicit input (e.g., commands, queries, and/or requests) to the automated assistant that can cause the automated assistant to generate and provide responsive output, to control one or more Internet of things (IoT) devices, and/or to perform one or more other functionalities (e.g., assistant actions). This explicit input provided by the user can be, for example, spoken natural language input (i.e., spoken utterances) which may in some cases be converted into text (or other semantic representation) and then further processed, and/or typed natural language input.

In some cases, automated assistants may include automated assistant clients that are executed locally by assistant devices and that are engaged directly by users, as well as cloud-based counterpart(s) that leverage the virtually limitless resources of the cloud to help automated assistant clients respond to users' inputs. For example, an automated assistant client can provide, to the cloud-based counterpart(s), audio data of a spoken utterance of a user (or a text conversion thereof), and optionally data indicative of the user's identity (e.g., credentials). The cloud-based counterpart may perform various processing on the explicit input to return result(s) to the automated assistant client, which may then provide corresponding output to the user. In other cases, automated assistants may be exclusively executed locally by assistant devices and that are engaged directly by users to reduce latency.

### SUMMARY

Implementations disclosed herein relate to generating and updating a customized automated assistant based on external resources. One or more resources, such as websites, applications, and/or documents can be identified by a developer and references to the document(s) can be provided to an application that can process the various documents to identify information included in the documents. Identified information can be utilized to customize one or more properties of an automated assistant. Subsequently, as the resources are updated, the resources can be re-processed and various aspects of the automated assistant can be updated accordingly.

As an example, a medical practice can create a customized automated assistant that is utilized by the practice to process incoming phone calls and/or other requests. The medical practice may have a website that includes information regarding the practice (e.g., general information, hours, services offered). A reference to the website can be provided to an application, which can process the website to identify potentially pertinent information included in one or more pages of the website. In response, the identified information can be utilized to parameterize the automated assistant's speech engine and/or NLU system such that domain-specific vocabulary is processed by the automated assistant more accurately. Further, a corpus of answers to common questions can be identified from the website such that, when a caller asks one of the common questions, a standardized response can be provided without requiring additional processing by the automated assistant. For example, the website of the medical practice may include a list of specializations, and a corpus of question/answers can include a query of “Do you specialize in cardiology” and/or “What types of medicine do you specialize in?,” which can be responded to with pre-generated responses (“No, we specialize in pediatrics and general medicine”). If subsequently, the medical practice adds a new practice area, the website can be updated and re-processed such that the corpus of questions and answers of the automated assistant are also updated to reflect any changes.

A developer can identify one or more documents and provide a location of the resources (e.g., a pointer, URL, reference) to an application that can process the resources to identify pertinent information in the resources. For example, resources can include documents within a company's domain, websites of an organization, applications that are utilized by a company, and/or sources of information that can be utilized to customize an automated assistant for use by the company and/or organization. The documents can be processed by, for example, crawling the text of the documents, identifying features of a website, and/or otherwise determining information contained in the resources. In some implementations, multiple types of resources can be identified and provided for further processing.

Once the resources have been identified, the information included in the documents can be parsed and aggregated. In some implementations, conflicting information can be resolved, either with additional input from the developer and/or by determining which information is more recent and/or was updated more recently and selecting the content that is more recent to further customize the automated assistant. For example, a document may include a FAQ of common questions and answers, and a website may include an FAQ that has somewhat different information. If the website was updated more recently than the document, the information from the website may be included in the customization information and the document may be excluded from the customization information. The corpus of information can then be stored in a database that includes all of the information that can be utilized to customize the automated assistant.

In some implementations, the customization information can be utilized to construct a custom language model. For example, terms that are identified in one or more of the resources can be utilized to determine one or more of the terms that are not commonly utilized by users in common contexts but are more likely to be utilized by a user in the context of a specific domain. For example, terms that appear multiple times throughout the resources but appear with a lower frequency in common contexts (e.g., regular user interactions with an automated assistant) can be identified using one or more techniques and further stored as part of a specialized dictionary of terms and/or a speech recognition engine can be biased to better recognize the domain-specific terms.

As an example, a medical office may have a specialization of “orthodontics,” which is not a term that commonly appears in general submitted search requests of users. However, a user of an automated assistant that has been customized for a medical office may commonly utilize the term. Therefore, a user uttering a search request of “Do you specialize in orthodontics” is more likely in the context of interacting with the medical office than for a non-customized automated assistant. The term “orthodontics” can be stored in a customized dictionary for the automated assistant of the medial office, and when a user provides a spoken query of “Do you specialize in orthodontics,” the speech recognition engine of the automated assistant may be more likely to recognize the term (i.e., less likely to misunderstand the term). By identifying terms that a speech recognition engine is more likely to misunderstand, a user will be less likely to have to repeat queries and/or determine alternate queries to be provided with the information that is being requested.

In some implementations, natural language representations of information included in one or more resources can be utilized for priming a large language model (LLM) for a specific context. Once primed, an LLM can be utilized to receive queries and provide responses that are specific to the domain in which the LLM was primed. For example, for a medical office, the LLM can be primed with the information included on the website of the office. When a user submits a query to an automated assistant, the LLM can be utilized to generate a response. For example, a user may submit a request of “Which doctor is available on Thursday,” and the request can be processed by the LLM to provide a response of “Dr. Smith is available at 7:00.”

In some implementations, natural language representations of information included in one or more resources can be utilized for fine-tuning a previously-trained LLM. For example, an LLM can be trained utilizing other resources to generate a model that can be utilized for general query processing. Additionally, resources that are specific to a particular type of query (e.g., queries specific to a particular field or corpus of knowledge) can be utilized to fine-tune the training of the LLM such that the resulting LLM is tuned to respond to queries related to the particular field with better accuracy as opposed to providing the same or similar queries to an LLM that was not fine-tuned.

Implementations described herein improve functionality of an automated assistant thereby conserving computing resources that are utilized when processing interactions between the automated assistant and a user. For example, by biasing speech recognition, misunderstanding by the automated assistant is reduced (i.e., fewer incorrect identifications of particular terms), thereby reducing the number of repeated interactions between the user and the automated assistant that may be required when the automated assistant does not recognize one or more terms that are common in a domain. Further, computing resources are reduced by customizing an automated assistant to respond to queries from a specific domain. Because the customized automated assistant is not required to generate responses to all queries (i.e., tailored to queries from a particular domain), the processing capabilities of the customized automated assistant can be limited to only those queries or types of queries that the domain-specific automated assistant would be expected to comprehend. Thus, the automated assistant need not process general knowledge queries and the memory required to execute the limited automated assistant would be less than required for a general knowledge automated assistant.

### BRIEF DESCRIPTION OF THE DRAWINGS

FIG. 1A and FIG. 1B respectively depicts a block diagram of an example environment that demonstrates various aspects of the present disclosure, and in which implementations disclosed herein may be implemented.

FIG. 2A depicts an example domain-specific resource document, in accordance with various implementations.

FIG. 2B depicts an example domain-specific resource application, in accordance with various implementations.

FIG. 3A depicts a dialog between a user and an automated assistant executing on a device.

FIG. 3B depicts another example between a user and an automated assistant via a mobile device.

FIG. 4A and FIG. 4B illustrate a flowchart of an example method in accordance with various implementations.

FIG. 5A and FIG. 5B illustrate a flowchart of another example method in accordance with various implementations.

FIG. 6 illustrates a flowchart of another example method in accordance with various implementations.

FIG. 7 illustrates an example architecture of a computing device

### DETAILED DESCRIPTION

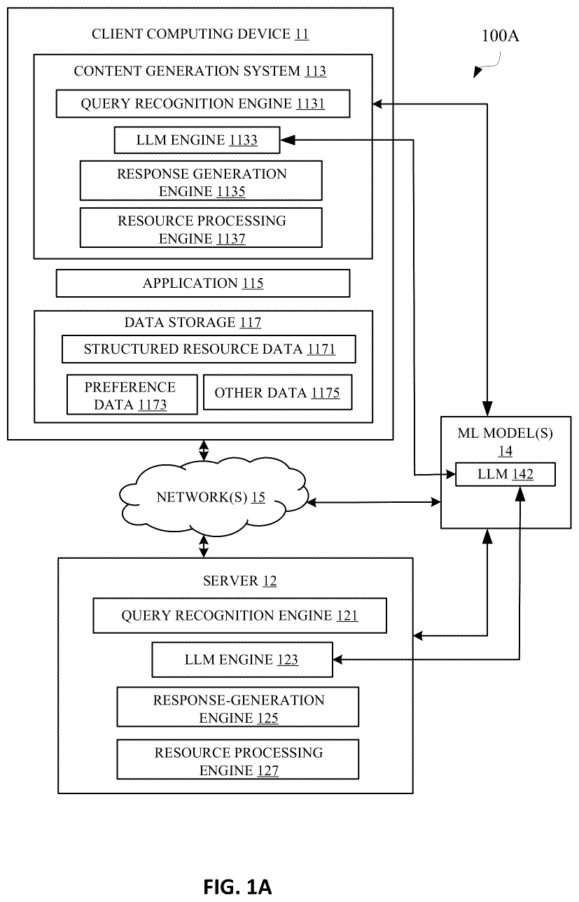

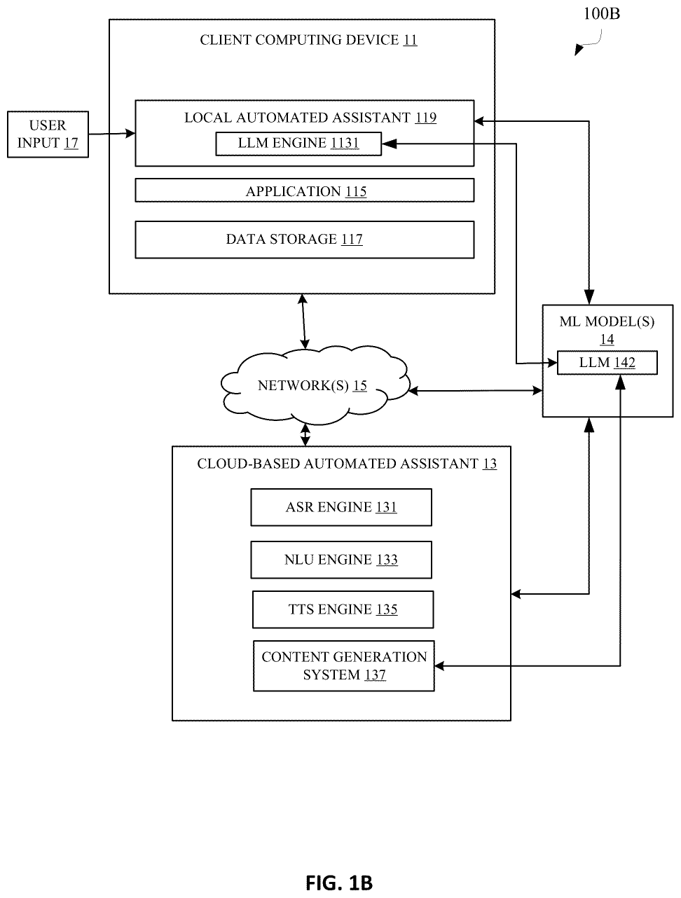

FIG. 1A is a block diagram of an example environment 100A that demonstrates various aspects of the present disclosure, and in which implementations disclosed herein may be implemented. As shown in FIG. 1A, the environment 100A can include a client computing device 11, and a server 12 in communication with the client computing device 11 via one or more networks 15. The client computing device 11 can be, for example, a cell phone, a laptop, a desktop, a notebook computer, a tablet, a smart TV, a messaging device, or a personal digital assistant (PDA), and the present disclosure is not limited thereto. The server computing device 13 can be, for example, a web server, a proxy server, a VPN server, or any other type of server as needed. The one or more networks 15 can include, for example, a local area network (LAN), a wide area network (WAN) such as the Internet, and/or any other appropriate network. In some implementations, the client computing device 11 can further include one or more data storage 117, where the one or more data storage 117 can store structured resource data 1171, unstructured data such as preference data 1173, and/or other data 1175 (e.g., electronic notes) described in this disclosure.

In some implementations, the client computing device 11 can include, or otherwise access, a content generation system 113 in communication with one or more machine learning (ML) models 14. The one or more ML models 14 can include, for example, a large language model (LLM) 142, where the LLM 142 can be a T5, PaLM, GPT-3, or other language model. The content generation system 113 can include, for example, a query recognition engine 1131, where the query recognition engine 1131 can process natural language content parsed from a received query (e.g., a query that is provided to an automated assistant) to determine whether the query is relevant to a particular field of knowledge and/or directed to elicit information related to resources that have been utilized to customize an LLM. For example, the query recognition engine 1131 can process a spoken utterance directly to determine whether the spoken utterance includes a query that is relevant to the subject matter of the resources utilized to prime or fine-tune an LLM.

In some implementations, a keyword and/or phrase in a query may include an indication of a particular LLM to utilize to process the query. For example, the user may utter a particular hotword and/or phrase to indicate that the query is directed to a particular entity that has an LLM available to respond to queries. In some implementations, all queries that are received via a particular client device 11 may be provided to the same LLM. For example, a client device 11 may be present in waiting room of a doctor's office or a lobby of a hotel, and all queries that are received by that client device 11 can be provided for processing utilizing the LLM that has been fine-tuned and/or otherwise trained to respond to queries related to the doctor's office and/or hotel.

As an example, the user of the client computing device 11 can receive a spoken utterance (e.g., “Hey Doctor's Office, can I make an appointment on Thursday?”) via an automated assistant (see FIG. 1B), where the spoken utterance is processed into natural language content (e.g., “can I make an appointment on Thursday” in natural language). The query recognition engine 1131 can process the natural language content to determine that the spoken utterance includes a hotword “Hey Doctor's Office” that indicates a particular target that the user has interest in providing a response. Thus, in this example, query recognition engine 1131 can determine that the subsequent query is related to a “Doctor's Office” entity and can utilize a language model that has been trained by the “Doctor's Office” and can prime an LLM with resources from the entity “Doctor's Office” when a response is determined for the query. Optionally or additionally, the query recognition engine 1131 can determine the query as a candidate for use in subsequent priming of the LLM 142.

In some implementations, the content generation system 113 can further include, for example, a LLM engine 1133 in communication with the LLM 142. The LLM engine 1133 can prime the LLM 142 using one or more priming input. The one or more priming input can include, for example, a first priming input generated based on one or more resources specific to a domain and/or one or more resources that are relevant to a particular query that has been submitted by the user via an utterance. Continuing with the above example in which the query recognition engine 1131 processes the natural language content (e.g., “can I make an appointment on Thursday”) from the spoken utterance (e.g., “Hey Doctor's Office, can I make an appointment on Thursday”) to determine that such natural language content includes a query (e.g., “can I make an appointment on Thursday”) relevant to an electronic calendar associated with the doctor's office, the LLM engine 1133 can generate a first priming input using entries of the electronic calendar information from the office calendar.

For example, a portion of the electronic calendar of the doctor's office having entries for other appointments of the doctor (e.g., unavailable time slots) can include a first entry (e.g., “patient visit, October 9th, 3 pm-4 pm”), a second entry (e.g., “vacation, from October 10^{th} (all day), to October 11th, 1 pm”), and a third entry (e.g., “lunch meeting, October 11th, 1:30 μm to 3 pm). The LLM engine 1133 can process the first, second, and third entries of the electronic calendar to generate a first priming input, where the first priming input can be, for example, in natural language content that includes a description of “Doctor is available October 9th before 3 pm or after 4 pm, and available on October 11^{th} between 1 μm and 1:30 pm or after 3 pm”. The LLM engine 1133 can the prime the LLM model 142 using the first priming input (e.g., “Doctor is available October 9th before 3 pm or after 4 pm, and available on October 11th between 1 μm and 1:30 pm or after 3 pm” in natural language, or “Doctor is available the rest of week on October 9th before 3 pm or after 4 pm, or on October 11th between 1 pm and 1:30 pm or after 3 pm” in natural language). After being primed using the first priming input, the LLM engine 1133 can process the query (e.g., “Can I see a doctor this week”) using the primed LLM model 142 to generate a LLM output. The LLM output, in this case, can be “on October 9th, the doctor has time for a meeting before 3 pm or after 4 pm, and on October 11th, the doctor has time for an appointment between 1 μm and 1:30 μm, or after 3 pm”.

In some implementations, the server 12 can include a query recognition engine 121, a LLM engine 123, a response-generation engine 125, and/or a resource processing engine 127. The query recognition engine 121 can be the same as (or similar to) the query recognition engine 1131 accessible locally at the client computing device 11. For example, the query recognition engine 121 can determine whether a message or a spoken utterance includes a query relevant to an electronic calendar. Being accessible via the server 12, the query recognition engine 121 may perform such determination in a more efficient way than the query recognition engine 1131. Accordingly, to prevent such determination occupying too much (or unnecessary) computing resources of the client computing device 11, the client computing device 11 may offload such determination process to the query recognition engine 121.

Similarly, the LLM engine 123 can be the same as or similar to the LLM engine 1133, the response generation engine 125 can be the same as or similar to the response generation engine 1135, and the calendar-processing engine 127 can be the same as or similar to the calendar-processing engine 1137. To put it in another way, the LLM engine 123 can be a cloud counterpart (e.g., offering service in a cloud computing environment) of the LLM engine 1133 at the client computing device 11, the response generation engine 125 can be a cloud counterpart of the response-generation engine 1135, and the resource processing engine 127 can be a cloud counterpart of the resource processing engine 1137. In this case, the environment 100A can be the cloud computing environment in which a plurality of computing devices, which can be in the order of hundreds or thousands or more, share resources over the one or more networks 15. Repeated descriptions can be found in descriptions of this specification, and thus are omitted here.

FIG. 1B depicts a block diagram of another example environment 100B that demonstrates various aspects of the present disclosure, and in which implementations disclosed herein may be implemented. As shown in FIG. 1B, the environment 100B can include the client computing device 11 having a local automated assistant 119. The environment 100B can further include a cloud-based automated assistant 13 that is in communication with the client computing device 11 via one or more networks 15. Optionally, the client computing device can include one or more applications 115, and a data storage 117. The local automated assistant 119 can access one or more ML models 14, and can include the aforementioned LLM engine 1131 in communication with the LLM 142 of the one or more ML models 14. The local automated assistant 119 can receive a user input 17 via an input device of the client computing device 11. For example, the user input 17 can be a spoken utterance, and be received by the local automated assistant 119 via a microphone of the client computing device 11. The user input 17 can also be a touch input, a camera input, or a keyboard input, received by the local automated assistant 119 via a touch screen, a camera, or a keyboard of the client computing device 11, and the present disclosure is not limited thereto.

The cloud-based automated assistant 13 can include an automatic speech recognition (ASR) engine 131, a natural language understanding (NLU) engine 133, a text-to-speech (TTS) engine 135, and a content generation system 137. The ASR engine 131 can process audio data that captures a spoken utterance to generate a recognition of the spoken utterance. The NLU engine 133 can determine semantic meaning(s) of audio and/or text converted by the ASR engine from audio, and decompose the determined semantic meaning(s) to determine intent(s) and/or parameter(s) for an assistant action. For example, the NLU engine 133 can determine an intent and/or parameters for an assistant action based on the aforementioned recognition of the spoken utterance generated by the ASR engine 131.

In some implementations, the NLU engine 133 can resolve the intent(s) and/or parameter(s) based on a single utterance of a user and, in other situations, prompts can be generated based on unresolved intent(s) and/or parameter(s), those prompts rendered to the user, and user response(s) to those prompt(s) utilized by the NLU engine 133 in resolving intent(s) and/or parameter(s). In those situations, the NLU engine 133 can optionally work in concert with a dialog manager engine (not illustrated) that determines unresolved intent(s) and/or parameter(s) and/or generates corresponding prompt(s). The NLU engine 133 can utilize one or more NLU machine learning models, out of the one or more ML models 14, in determining intent(s) and/or parameter(s).

The TTS engine 135 can convert text to synthesized speech, and can rely on one or more speech synthesis neural network models in doing so. The TTS engine 135 can be utilized, for example, to convert a textual response into audio data that includes a synthesized version of the text, and the synthesized version can be audibly rendered via hardware speaker(s) of the client computing device 11 or another device. The content generation system 137 can be the same as or similar to the aforementioned content-generation system 113, and repeated descriptions are not provided herein.

In some implementations, an automated assistant (i.e., local automated assistant 119) can, for example, use the NLU 133 (accessible locally or remotely) to determine that audio data received via one or more microphones of device 100A includes a spoken query (e.g., “What are your hours”). The automated assistant (i.e., the local automated assistant 119) can process the query locally (if the automated assistant includes or otherwise can access the content generation system 113), or forward the query to the cloud-based automated assistant 13 for remote processing. The query can be processed locally or remotely to determine that the query is relevant to a particular domain, for example, based on the automated assistant identifying one or more terms that are included in the query. In this case, the automated assistant can prime the LLM model 142 using one or more natural language representations of one or more resources and then process the query using the LLM model 142 that is primed with the resource, where the primed LLM model 142 processes the queries that are related to the identified domain of the query.

Optionally, the automated assistant can further determine, using the content generation system 113 and based on the LLM output, a response to the query. For example, the automated assistant can determine, based on the LLM output (e.g., “I don't have time tomorrow”) and based on the entry (e.g., “vacation to Puerto Rico from February 3rd to February 16th”), that the response includes a natural language response, e.g., “I don't have time tomorrow. I am away from February 3rd to February 16th” or “I don't have time tomorrow, my whole calendar tomorrow is full.” The automated assistant can cause the natural language response (e.g., “I don't have time tomorrow, my whole calendar tomorrow is full.”) to be rendered as a selectable element via an interface of the instant messaging application. When selected, the natural language response (e.g., “I don't have time tomorrow, my whole calendar tomorrow is full.”) can be entered into a text-input field at the interface of the instant messaging application as a reply (or part of the reply) to the aforementioned text message (e.g., “Liam, do you have time tomorrow? just curious”). The natural language response can be sent out directly, or can be edited before being sent out. This way, a user does not need to check his or her calendar(s) to formulate a response to a query relevant to his or her calendar(s).

In some implementations, resource processing engine 1137 can be provided with one or more resources that are specific to a domain. A domain can include any field of information that is related, such as resources that are all related to the same subject, information specific to a particular entity, and/or other information that otherwise is directed to a particular topic. For example, resources can be related to a business and can include web pages of the business, applications that can be utilized to interact with the business, and/or other documents that include information that is pertinent to the business.

In some implementations, one or more of the resources may include links to additional resources. For example, resource processing engine 1137 may be provided with a web page that has links to additional web pages. Resource processing engine 1137 may access the links to the additional web pages and include those web pages as additional resources when processing the domain-specific resources. In some implementations, the resources that are provided to the resource processing engine 1137 may be of multiple types. For example, a document may be provided as a resource along with a link to a web page and an application that can be utilized to interact with a business.

In some implementations, resource processing engine 113 can process the domain-specific resources to generate a natural language representation of the information included in the resources. In some implementations, processing the resources may include resolving inconsistencies in the resources. For example, a first document may include a “FAQ” page for a business and a second resource may be a web page of the business that additionally includes an “FAQ” section. If the information in the two documents conflicts, the resource processing engine 1137 may determine which of the documents has been more recently modified and only process the information from that document (and/or only process the portions that conflict from that document and ignore the conflicting information included in the other document).

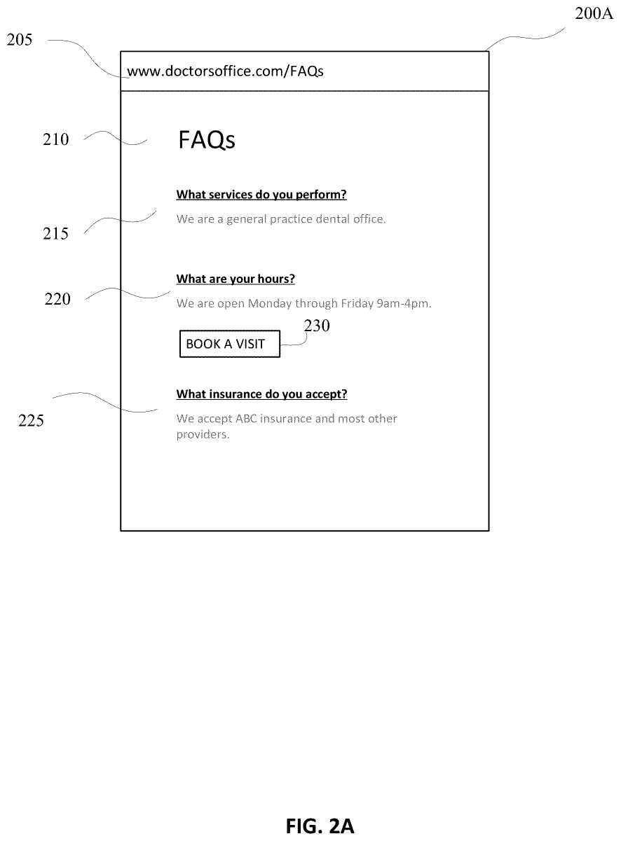

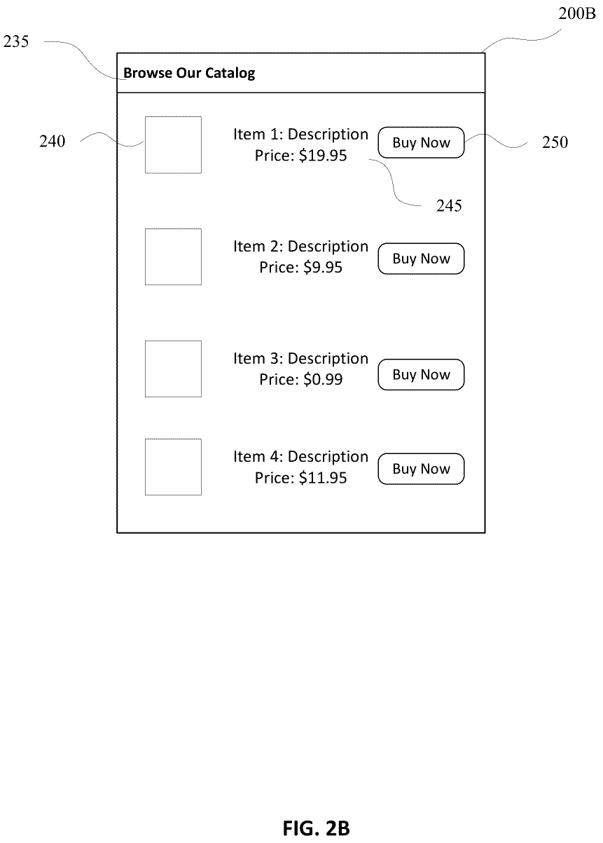

Referring to FIG. 2A, a document is illustrated that includes a resource that can be provided to the resource processing engine 1137. In this example, a web page 200A is illustrated that includes an “FAQ” section 210. The “FAQ” section 210 includes a first question and answer 215, a second question and answer 220, and a third question and answer 225. In some implementations, the web page 200A can be provided to the resource processing engine 1137 by providing the URL 205 of the web page 200A. Thus, resource processing engine 1137 can process the information included in the web page 200A and further follow any links in the web page, such as link 230. The web page and/or application that is accessed via link 230 may then additionally be processed.

Referring to FIG. 2B, an application interface is illustrated that can be provided to resource processing engine 1137 as a resource. In the example, an interface 200B includes a title 235 that indicates that the interface is illustrating items that are available to purchase. For example, itel 240 may be an image of an item that has a corresponding description 245 and a button 250 to purchase the item. In some implementations, resource processing engine 1137 can process the text of interface 200B and further determine the functionality of the button(s) 250.

In some implementations, the natural language representation that is generated by resource processing engine 1137 can be utilized to customize one or more aspects of an automated assistant. For example, in some implementations, the natural language representation can be utilized to prime and/or fine-tune a large language model (LLM). In some implementations, the natural language representation can be utilized to identify terms that are unique to the particular domain and generate a grammar that includes those words for assistant in speech recognition (e.g., biasing those terms to assist in speech to text processing). For example, terms that are included in the resources but are otherwise not common in other documents may be weighed more heavily in speech recognition so that, when a user provides a spoken utterance with one of those terms, the terms is recognized by the automated assistant.

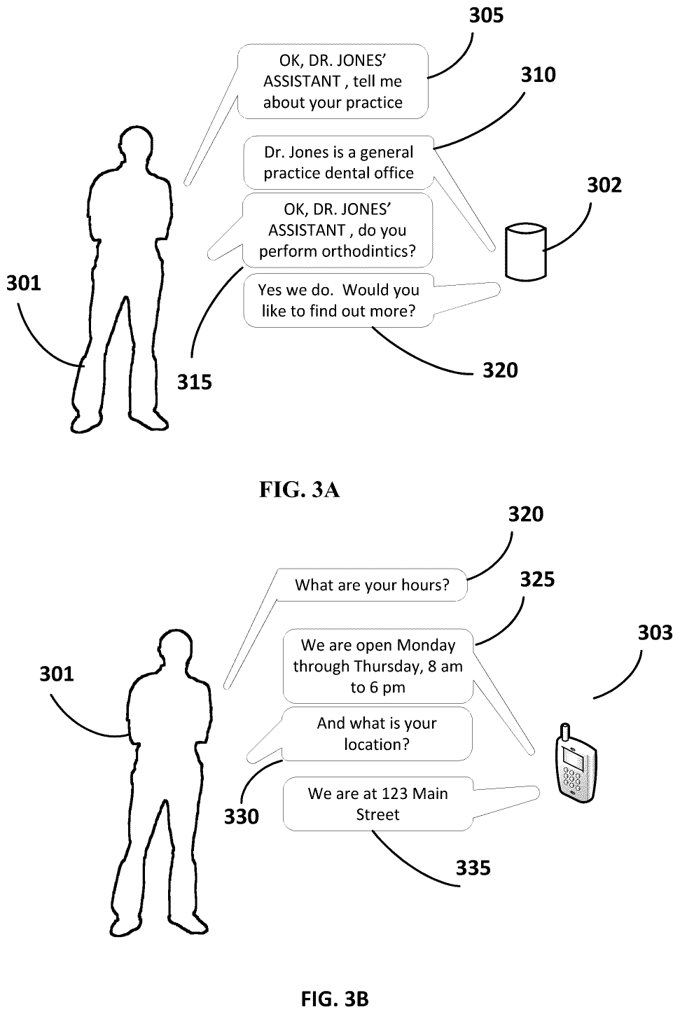

As an example, referring to FIG. 3A, a dialog between a user 301 and an automated assistant executing on a smart speaker 302 is illustrated. The user utters a spoken utterance 305 that includes one or more hotwords (e.g., “OK Dr. Jones' Assistant”) that indicates that the proceeding query is directed to a particular automated assistant. The query can be provided to an LLM with the natural language representation as priming input and the output from the LLM can be utilized to generate a response 310. In dialog 315, the response includes the term “orthodontics,” which may not be a common term that is provided to an automated assistant. However, in some instances, the term “orthodontics” may be present in one or more of the domain-specific resources that were processed, and therefore speech recognition may be biased to the term to assist the automated assistant in recognizing the term. The query may be provided as input to the LLM with a natural language representation of the one or more domain-specific resources as input and the output from the LLM can be utilized to generate response 320.

In some implementations, the hotword (or a warmword) that indicates which automated assistant model to utilize when processing a query can be determined based on one or more terms included in the domain-specific resources. For example, the hotwords “Dr. Jones' Office” may be included in one or more web pages that were included in the resources. Also, for example, one or more applications that were included with the domain-specific resources may include the term “Dr. Jones” one or more times and the automated assistant that is customized utilizing the resources may be associated with “Dr. Jones' Office” as a hotword.

In some implementations, a personality for an automated assistant can be adjusted based on the one or more resources that were processed by resource processing engine 1137. For example, when generating a response to a user query, the tone of the synthesized speech and/or word usage can be adjusted based on the domain that is specific to the resources. As a specific example, a doctor's office automated assistant may be more formal and include one or more terms that would not be included in an automated assistant for a comic book store. Thus, based on processing the resources, an appropriate tone and/or dictionary of appropriate terms can be determined and utilized when generating responses to user queries.

In some implementations, one or more actions may be included in the resources and the automated assistant can be configured to perform the one or more actions. For example, as previously illustrated in FIG. 3B, a “buy” button is included with items via the application. In some instances, a user can select the “buy” button and cause the associated item to be added to a shopping cart and/or automatically purchased. In some implementations, processing the application can include identifying the functionality of the “buy” button and further facilitating the same action via a customized automated assistant.

In some implementations, the one or more resources can be periodically reviewed to determine whether any of the resources has been updated and/or otherwise changed (e.g., no longer available, a new version of an application is made available). For example, an FAQ webpage may have operating hours for a business and the business may change its hours of operation. In response, when the resource is reviewed, the change can be identified (e.g., via timestamp associated with the web page, comparing the web page to a previously reviewed version of the web page) and the content can be re-processed. An updated natural language representation can be generated and the updated natural language representation can be utilized as priming input to an LLM and/or to otherwise adjust the fine-tuning of the LLM.

As another example, referring to FIG. 3B, a second dialog between the user 301 and an automated assistant that is executing on a smartphone 303. For example, the user 301 may call a dentist's office and instead of a human answering the phone call, an automated assistant can answer the phone call and interact with the user as if the user were interacting with another human. In this instance, a hotword is not included because the user 301 has only one automated assistant with which he/she can interact. Thus, the user 301 can utter a spoken query 320 without indicating which automated assistant should process the query. Response 325 can be generated in a similar manner as previous responses. The user 301 may provide one or more follow-up queries 330 and further be provided with additional responses 335.

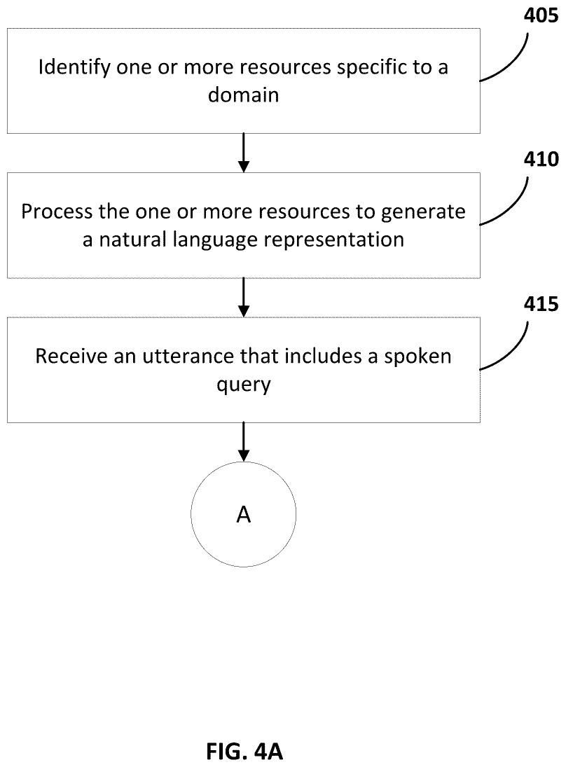

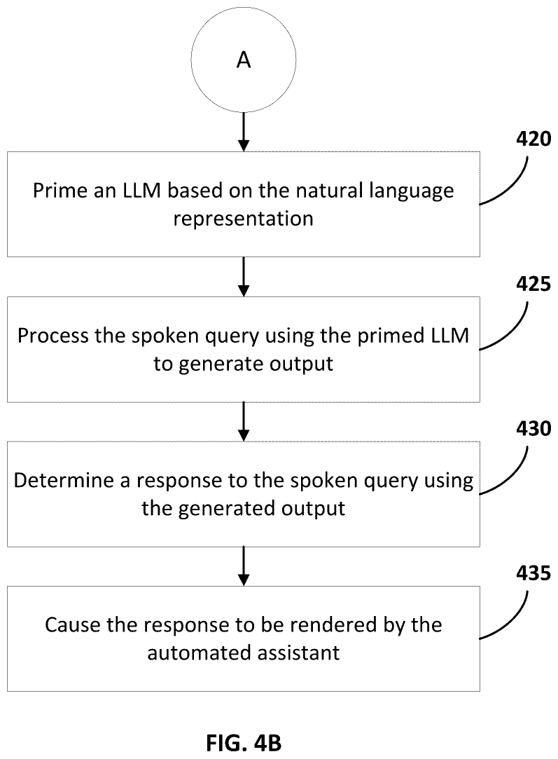

Referring to FIGS. 4A and 4B, a flowchart is provided that illustrates a method for determining a response to provide to a user utilizing a large language model. In some implementations, one or more steps of the method can be omitted or combined, and/or one or more additional steps can be included in the method. The method can be performed by one or more components that are illustrated in the environment of FIG. 1.

At step 405, one or more resources that are specific to a domain are identified. The one or more resources can include URLs, other pointers to application, activities that can be performed by a mobile device, documents within a domain of an entity (e.g., webpages and/or other documents of a business), and/or other resources that are utilized by one or more users that include information related to a particular domain.

At step 410, the one or more resources identified at step 405 are processed to generate a natural language representation. Processing the one or more resources can include processing the information included in one or more documents, identifying and processing additional documents and/or applications that are referenced by documents and/or applications that are included in the resource(s) (e.g., “crawling” a webpage), and/or other processing that can generate a natural language representation of the information included in the one or more resources.

At step 415, an utterance is received that includes a spoken query. The utterance may be directed to an automated assistant, such as automated assistant 119 of FIG. 1B. In some implementations, the utterance may share one or more characteristics with the utterance illustrated in FIG. 3A as utterance 305 and/or utterance 320 of FIG. 3B. For example, the utterance may include a hotword that, when included in an utterance, indicates that the utterance is directed to a particular automated assistant (e.g., “OK Assistant”). In some implementations, any utterances that are received by the automated assistant may be directed to the automated assistant (e.g., all utterances spoken by user 301 that are spoken to mobile device 303).

At step 420, a large language model (LLM) is primed based on at least a portion of the natural language representation generated at step 410. Priming an LLM can include providing text and/or a natural language representation to the LLM as input that can be utilized by the LLM to generate output that shares some characteristics with the priming input. For example, by providing the LLM with a natural language input that includes information from a FAQ web page of an entity, the LLM may be primed to provide output that shares one or more characteristics with the FAQ web page.

At step 425, the spoken query is processed using the primed LLM to generate output. The generated output may be a natural language representation of output that is responsive to the spoken query. In some implementations, the output can share one or more characteristics with the priming input that was provided with the spoken query (e.g., similar structure, word usage, tone, information). Thus, by priming with a natural language representation from a particular domain, the output from the LLM can be presented to the user in a similar manner as the one or more resources that were utilized to generate the natural language representation.

At step 430, a response to the spoken query is determined based on the generated output of the LLM. For example, a TTS module can generate a spoken version of a textual response that is generated based on the output of the LLM. For example, the LLM can generate, as output, “Dr. Jones is a general practice dental office,” and a TTS module can generate synthesized speech that includes the phrase that is included in (or generated from) the LLM output. At step 435, the response is rendered to the user via the automated assistant (e.g., audio data that includes the spoken response can be provided to the user via one or more microphones of the device that is executing the automated assistant).

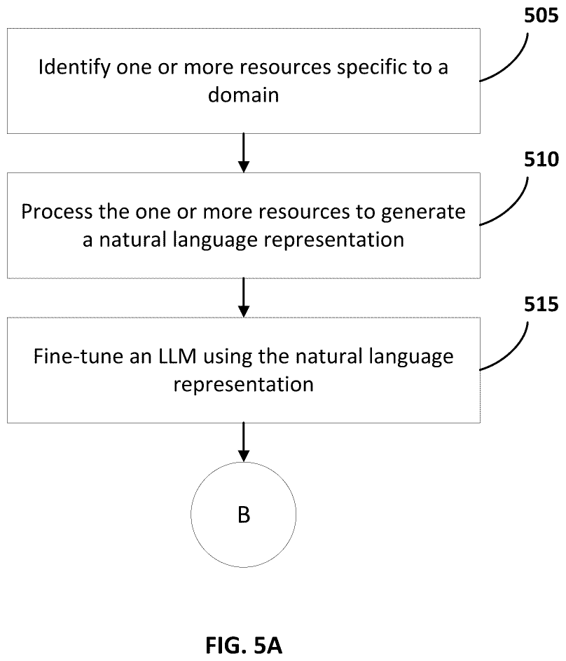

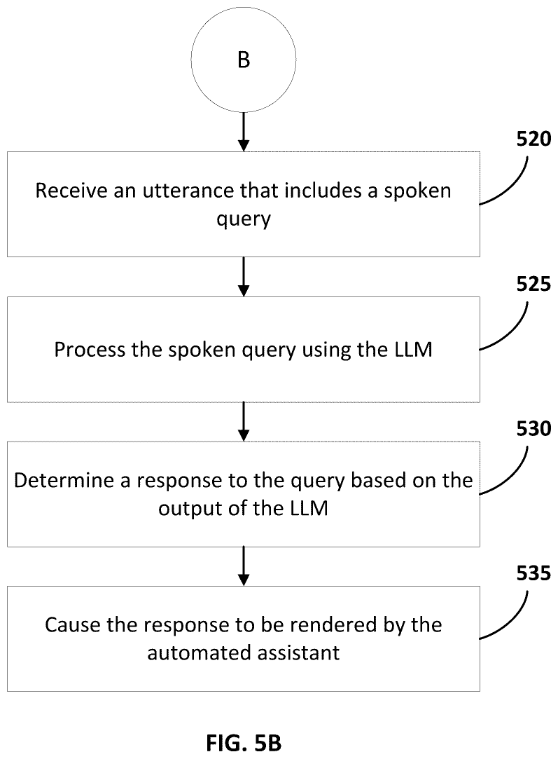

Referring to FIGS. 5A and 5B, a flowchart is provided that illustrates another method for providing a response to a request from a user utilizing a large language model. In some implementations, one or more steps of the method can be omitted or combined, and/or one or more additional steps can be included in the method. The method can be performed by one or more components that are illustrated in the environment of FIG. 1.

At step 505, one or more resources are identified that are specific to a domain. Step 505 shares one or more characteristics with step 405 of FIG. 4A. At step 510, the one or more resources identified at step 505 are processed to generate a natural language representation. Step 510 can share one or more characteristics with step 410 of FIG. 4A.

At step 515, a large language model (LLM) is fine-tuned using the natural language representation. Fine-tuning an LLM can include adjusting one or more layers of the LLM based on the natural language representation of the one or more resources. Thus, once fine-tuned, the LLM can be utilized for a specific application, such as to process queries that are relevant to the domain.

At step 520, an utterance is received that includes a spoken query. The utterance may be directed to an automated assistant, such as automated assistant 119 of FIG. 1B. In some implementations, the utterance may share one or more characteristics with the utterance illustrated in FIG. 3A as utterance 305 and/or utterance 320 of FIG. 3B. For example, the utterance may include a hotword that, when included in an utterance, indicates that the utterance is directed to a particular automated assistant (e.g., “OK Assistant”). In some implementations, any utterances that are received by the automated assistant may be directed to the automated assistant (e.g., all utterances spoken by user 301 that are spoken to mobile device 303).

At step 525, the spoken query is processed using the LLM to generate output. The LLM output can be a response to the spoken query and/or may include information that can be utilized to determine a response to the spoken query. For example, for a query of “What are your hours” that is provided as input to the LLM, generated output of “Monday through Friday, 8 am to 5 pm” can be utilized to determine a response of “We are open Monday through Friday, 8 am to 5 pm.”

At step 530, a response to the query is determined based on the generated output of the LLM. Determining a response can include selecting word usage, tone, and/or other features of a response that can be rendered to the user. For example, as previously described, the LLM output can include “Monday through Friday, 8 am to 5 pm” and particular word usage can be selected for the response based on the one or more resources that were previously processed. Also, for example, a tone for the response can be determined based on the resources such that, for example, a doctor's office automated assistant may have a more formal tone than a comic book store automated assistant based on identifying that one or more of the resources is in a more formal format.

At step 535, the automated assistant causes the response to be rendered to the user. The response can be provided as synthesized speech generated by the automated assistant. In some implementations, the response can be provided via one or more speakers of a smart device, such as a smart speaker, and/or via a phone with the user, as illustrated in FIG. 3B.

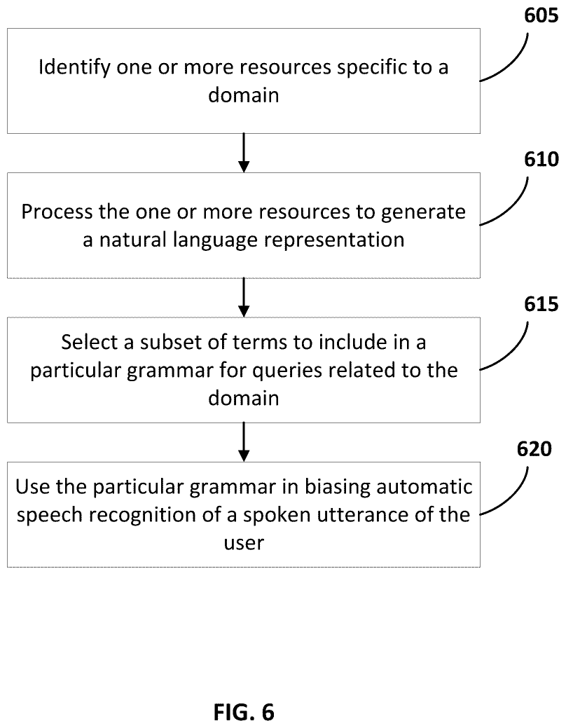

Referring to FIG. 6, a flowchart is provided that illustrates a method determining a particular grammar based on one or more domain specific resources. In some implementations, one or more steps of the method can be omitted or combined, and/or one or more additional steps can be included in the method. The method can be performed by one or more components that are illustrated in the environment of FIG. 1.

At step 605, one or more resources that are specific to a domain are identified. Step 605 shares one or more characteristics with step 405 of FIG. 4A. At step 610, the one or more resources identified at step 505 are processed to generate a natural language representation. Step 610 can share one or more characteristics with step 410 of FIG. 4A.

At step 615, a subset of terms is selected to include in a particular grammar for queries that are related to the domain. Terms can be selected that appear within the one or more resources more frequently than the terms appear in other dialogs and/or resources. As an example, a dentist's office may utilize the term “orthodontics” frequently and that term may appear in resources associated with the dentist's office with greater frequency than the term appears in other documents unrelated to the field of dentistry. Thus, the term “orthodontics” may be included in a particular grammar that can be utilized by an automated assistant that is specific to a dentist's office such that, when a user utters the term “orthodontics,” the term is recognized by the ASR engine 131.

At step 620, the particular grammar is utilized in biasing automatic speech recognition of a spoken utterance of a user. Speech recognition can be performed by a component that shares one or more characteristics with automatic speech recognizer 131. For example, an automatic speech recognition model may be configured to recognize terms of the particular grammar such that, in instances where the user utters a phrase that includes the particular language (as opposed to the primary language of which the ASR is configured to recognize), the ASR can more likely recognize the terms in the particular language.

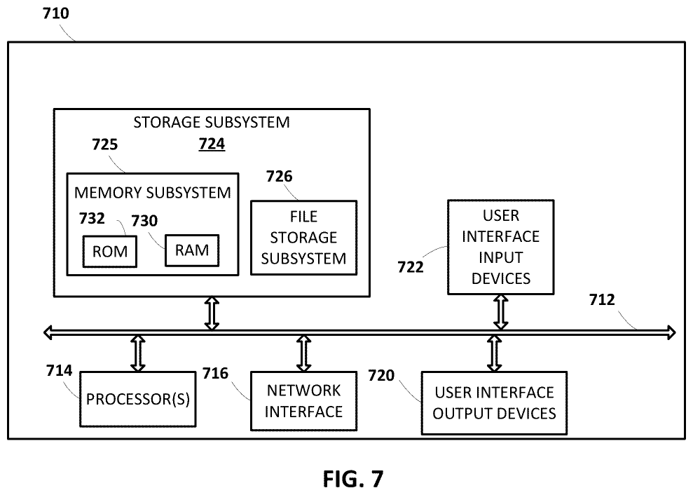

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods of FIG. 5 and FIG. 6, and/or to implement various components depicted in FIG. 2 and FIG. 3.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In some implementations, a method implemented by one or more processors is provided and includes identifying one or more resources, wherein the one or more resources include domain-specific information related to a domain, processing the one or more resources, to generate a natural language representation of the domain-specific information, and receiving an utterance that includes a spoken query, wherein the spoken query is directed to an automated assistant. In response to receiving a query determined to be related to the domain, the method further includes priming a large language model (LLM) using a priming input that is based on the natural language representation, wherein priming the LLM using the priming input comprises processing the priming input using the LLM. Following priming of the LLM using at least the priming input, the method includes processing, using the LLM, the spoken query, to generate an LLM output, determining, based on the LLM output, a response to the spoken query, wherein the response includes a natural language response, and causing the natural language response to be rendered by the automated assistant.

These and other implementations of the technology disclosed herein can include one or more of the following features.

In some implementations, the one or more resources includes one or more documents that include the domain-specific information related to the domain. In some of those implementations, the one or more resources includes one or more frequently asked questions and one or more responses to the one or more frequently asked questions.

In some implementations, processing the one or more resources includes identifying one or more terms that are included in the domain-specific information, determining that the one or terms are present in the one or more resources with a greater frequency than the presence of the one or more terms in one or more non-domain specific resources, and priming the LLM using the one or more terms.

In some implementations, the method further includes identifying that one or more of the resources has been updated, reprocessing one or more of the resources to generate an updated natural language representation of the domain-specific information, and priming the LLM using an updated priming input that is based on the updated natural language representation.

In some implementations, a particular resource of the one or more resources is an application, and processing the particular resource includes identifying an action that can be performed by the application, and processing the action to generate an action natural language representation of the action. In some of those implementations, the action is scheduling an event via a calendar application. In some of those implementations, the action includes purchasing an item.

In some implementations, another method implemented by one or more processors is provided and includes identifying one or more resources, wherein the one or more resources include domain-specific information related to a domain. processing the one or more resources, to generate a natural language representation of the domain-specific information, fine-tuning a large language model (LLM) using input that is based on the natural language representation, receiving an utterance that includes a spoken query, wherein the spoken query is directed to an automated assistant, processing, using the LLM, the spoken query, to generate an LLM output, determining, based on the LLM output, a response to the query, wherein the response includes a natural language response, and causing the response to be rendered by the automated assistant.

These and other implementations of the technology disclosed herein can include one or more of the following features.

In some implementations, processing the one or more resources includes identifying a first resource of the one or more resources that includes first information, identifying a second resource of the one or more resources that includes second information that is conflicting with the first information, determining that the first resource has been updated more recently than the second resource, and processing the first resource without processing the second resource.

In some implementations, processing the one or more resources includes identifying a first resource of the one or more resources that includes first information, identifying a second resource of the one or more resources that includes second information that is conflicting with the first information, determining that the first resource has been updated more recently than the second resource, and processing the first resource without processing the second resource.

In some implementations, the one or more resources includes one or more documents that include the domain-specific information related to the domain. In some of those implementations, the one or more resources includes one or more frequently asked questions and one or more responses to the one or more frequently asked questions.

In some implementations, the method further includes identifying that one or more of the resources has been updated, reprocessing one or more of the resources to generate an updated natural language representation of the domain-specific information, and updating the fine-tuning of the LLM based on the updated natural language representation.

In some implementations, a particular resource of the one or more resources is an application, and processing the particular resource includes identifying an action that can be performed by the application, and processing the action to generate an action natural language representation of the action. In some of those implementations, the action is scheduling an event via a calendar application. In some of those implementations, the action includes purchasing an item.

In some implementations, yet another method implemented by one or more processors is provided and includes identifying one or more resources, wherein the one or more resources include domain-specific information related to a domain, processing the one or more resources, to generate a natural language representation of the domain-specific information, and selecting, based on the natural language representation, a subset of the terms to include in a particular grammar for queries related to the domain. In response to selecting the particular grammar for queries related to the domain, the method further includes using the particular grammar in biasing automatic speech recognition of a spoken utterance of a user, wherein the automatic speech recognition is performed using a speech recognition model for the domain.

These and other implementations of the technology disclosed herein can include one or more of the following features.

In some implementations, the method further includes receiving a spoken query from the user, wherein the spoken query includes one or more terms of the grammar, determining, utilizing the one or more speech recognition models, a textual representation of the spoken query, and determining a response to the spoken query.

In some implementations, the method further includes providing the response to the user, wherein the response includes one or more terms of the grammar.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include an automated assistant client device (e.g., a client device including at least an automated assistant interface for interfacing with cloud-based automated assistant component(s)) that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

In situations in which certain implementations discussed herein may collect or use personal information about users (e.g., user data extracted from other electronic communications, information about a user's social network, a user's location, a user's time, a user's biometric information, and a user's activities and demographic information, relationships between users, etc.), users are provided with one or more opportunities to control whether information is collected, whether the personal information is stored, whether the personal information is used, and how the information is collected about the user, stored and used. That is, the systems and methods discussed herein collect, store and/or use user personal information only upon receiving explicit authorization from the relevant users to do so.

For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user's geographic location may be generalized to a larger region so that the user's particular location cannot be determined.

1. A method implemented by one or more processors, the method comprising:
identifying one or more resources, wherein the one or more resources include domain-specific information related to a domain;
processing the one or more resources, to generate a natural language representation of the domain-specific information;
receiving an utterance that includes a spoken query, wherein the spoken query is directed to an automated assistant;
in response to receiving a query determined to be related to the domain:
priming a large language model (LLM) using a priming input that is based on the natural language representation, wherein priming the LLM using the priming input comprises processing the priming input using the LLM;
following priming of the LLM using at least the priming input:
processing, using the LLM, the spoken query, to generate an LLM output;
determining, based on the LLM output, a response to the spoken query, wherein the response includes a natural language response; and
causing the natural language response to be rendered by the automated assistant.

2. The method of claim 1, wherein the one or more resources includes one or more documents that include the domain-specific information related to the domain.

3. The method of claim 2, wherein the one or more resources includes one or more frequently asked questions and one or more responses to the one or more frequently asked questions.

4. The method of claim 1, wherein processing the one or more resources includes:
identifying one or more terms that are included in the domain-specific information;
determining that the one or terms are present in the one or more resources with a greater frequency than the presence of the one or more terms in one or more non-domain specific resources; and
priming the LLM using the one or more terms.

5. The method of claim 1, further comprising:
identifying that one or more of the resources has been updated;
reprocessing one or more of the resources to generate an updated natural language representation of the domain-specific information;
priming the LLM using an updated priming input that is based on the updated natural language representation.

6. The method of claim 1, wherein a particular resource of the one or more resources is an application, and wherein processing the particular resource includes:
identifying an action that can be performed by the application; and
processing the action to generate an action natural language representation of the action.

7. The method of claim 6, wherein the action is scheduling an event via a calendar application.

8. The method of claim 6, wherein the action includes purchasing an item.

9. A method implemented by one or more processors, the method comprising:
identifying one or more resources, wherein the one or more resources include domain-specific information related to a domain;
processing the one or more resources, to generate a natural language representation of the domain-specific information;
fine-tuning a large language model (LLM) using input that is based on the natural language representation;
receiving an utterance that includes a spoken query, wherein the spoken query is directed to an automated assistant;
processing, using the LLM, the spoken query, to generate an LLM output;
determining, based on the LLM output, a response to the query, wherein the response includes a natural language response; and
causing the response to be rendered by the automated assistant.

10. The method of claim 9, wherein processing the one or more resources includes:
identifying a first resource of the one or more resources that includes first information;
identifying a second resource of the one or more resources that includes second information that is conflicting with the first information;
determining that the first resource has been updated more recently than the second resource; and
processing the first resource without processing the second resource.

11. The method of claim 9, wherein the one or more resources includes one or more documents that include the domain-specific information related to the domain.

12. The method of claim 11, wherein the one or more resources includes one or more frequently asked questions and one or more responses to the one or more frequently asked questions.

13. The method of claim 9, further comprising:
identifying that one or more of the resources has been updated;
reprocessing one or more of the resources to generate an updated natural language representation of the domain-specific information; and
updating the fine-tuning of the LLM based on the updated natural language representation.

14. The method of claim 9, wherein a particular resource of the one or more resources is an application, and wherein processing the particular resource includes:
identifying an action that can be performed by the application; and
processing the action to generate an action natural language representation of the action.

15. The method of claim 14, wherein the action is scheduling an event via a calendar application.

16. The method of claim 14, wherein the action includes purchasing an item.

17. A method implemented by one or more processors, the method comprising:
identifying one or more resources, wherein the one or more resources include domain-specific information related to a domain;
processing the one or more resources, to generate a natural language representation of the domain-specific information;
selecting, based on the natural language representation, a subset of the terms to include in a particular grammar for queries related to the domain; and
in response to selecting the particular grammar for queries related to the domain:
using the particular grammar in biasing automatic speech recognition of a spoken utterance of a user, wherein the automatic speech recognition is performed using a speech recognition model for the domain.

18. The method of claim 17, further comprising:
receiving a spoken query from the user, wherein the spoken query includes one or more terms of the grammar;
determining, utilizing the one or more speech recognition models, a textual representation of the spoken query; and
determining a response to the spoken query.

19. The method of claim 18, further comprising:
providing the response to the user, wherein the response includes one or more terms of the grammar.
